(19) United States
(12) Patent Application Publication
(10) Pub. No.: US 2020/0224606 A1
(43) Pub. Date: Jul. 16, 2020

(54) AIRCRAFT WITH GEARBOX DUAL PROPULSOR SYSTEM

(71) Applicant: Rolls-Royce North American Technologies Inc., Indianapolis, IN (US)

(72) Inventor: Douglas D. Dierksmeier, Franklin, IN (US)

(21) Appl. No.: 16/245,785

(22) Filed: Jan. 11, 2019

(51) Int. Cl. F02K 3/02; F16H 48/22; F16H 48/08; F02K 3/04; F02C 7/36

(52) U.S. Cl. CPC F02K 3/025; F16H 48/22; F02C 7/36; F02K 3/04; F16H 48/08

(57) ABSTRACT

A gas turbine engine system includes a gas turbine engine, a gearbox, a first propulsor, and a second propulsor. The gas turbine engine is coupled with an input shaft of the gearbox and configured to power the gearbox during operation of the gas turbine engine. The gearbox is configured to drive selectively the first propulsor and the second propulsor.

### FIELD OF THE DISCLOSURE

The present disclosure relates generally to gas turbine engines, and more specifically to gearbox systems for use with gas turbine engine systems.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

The output shaft is sometimes coupled to a propulsor such as a turbo-prop or turbofan via a gearbox. The propulsor generates thrust to propel the aircraft. The gearbox transmits torque from the output shaft to the propulsor while compensating for a rotational speed between the output shaft and the propulsor.

### SUMMARY

The present disclosure may comprise one or more of the following features and combinations thereof.

A gas turbine engine system may include a gearbox, a gas turbine engine, a first propulsor, and a second propulsor. The gearbox may include a differential, a first brake, and a second brake. The differential may include an input shaft, a first output shaft, and a second output shaft. The first brake may be coupled with the first output shaft and may be movable between an engaged position in which the first brake blocks rotation of the first output shaft and a disengaged position in which the first output shaft is free to rotate. The second brake may be coupled with the second output shaft and may be movable between an engaged position in which the second brake blocks rotation of the second output shaft and a disengaged position in which the second output shaft is free to rotate.

The gas turbine engine may be coupled to the input shaft of the differential. The gas turbine engine may be configured to drive the differential during operation of the gas turbine engine. The first propulsor may be coupled with the first output shaft included in the differential of the gearbox. The first propulsor may be configured to rotate about a first axis selectively to propel the gas turbine engine system in response to rotation of the first output shaft. The second propulsor may be coupled with the second output shaft included in the differential of the gearbox. The second propulsor may be configured to rotate about a second axis selectively to propel the gas turbine engine system in response to rotation of the second output shaft.

The gearbox may be operable in a first power mode and a second power mode. In the first power mode, the first brake is disengaged and the second brake is engaged so that the gas turbine engine system is propelled only by the first propulsor. In the second power mode, the first brake is engaged and the second brake is disengaged so that the gas turbine engine system is propelled only by the second propulsor.

In some embodiments, the gearbox may be further operable in a third power mode in which the first brake is disengaged and the second brake is disengaged. In some embodiments, the first axis intersects the second axis. In some embodiments, the first axis and the second axis are coaxial.

In some embodiments, the first axis is perpendicular to the second axis. In some embodiments, the first axis is substantially vertical and the second axis is substantially horizontal relative to ground.

In some embodiments, the gas turbine engine includes a drive shaft that extends along an engine axis. The first output shaft may be spaced apart radially from and may be parallel with the drive shaft relative to the engine axis. The second output shaft may be spaced apart radially from and may be parallel with the drive shaft relative to the engine axis. The differential may include a bevel gear coupled with the first output shaft and configured to drive the first propulsor.

According to another aspect of the present disclosure, a gas turbine engine system includes a gas turbine engine, a gearbox, a first propulsor, and a second propulsor. The gearbox may include a differential, a first brake, and a second brake. The differential may include an input shaft coupled with the gas turbine engine, a first output shaft, and a second output shaft. The first brake may be coupled with the first output shaft and configured to block selectively rotation of the first output shaft. The second brake may be coupled with the second output shaft and configured to block selectively rotation of the second output shaft. The first propulsor may be configured to be rotated about a first axis by the first output shaft. The second propulsor may be configured to be rotated about a second axis by the second output shaft.

In some embodiments, the first brake may be movable between an engaged position in which the first brake blocks rotation of the first output shaft and a disengaged position in which the first output shaft is free to rotate. The second brake may be movable between an engaged position in which the second brake blocks rotation of the second output shaft and a disengaged position in which the second output shaft is free to rotate and drive rotation of the second propulsor.

In some embodiments, the gearbox may be operable in a first power mode and a second power mode. In the first power mode, the first brake is disengaged and the second brake is engaged so that the gas turbine engine system is propelled only by the first propulsor. In the second power mode, the first brake is engaged and the second brake is disengaged so that the gas turbine engine system is propelled only by the second propulsor.

In some embodiments, the first axis intersects the second axis. In some embodiments, the first axis is perpendicular to the second axis. In some embodiments, the first axis extends in a vertical direction and the second axis extends in a horizontal direction relative to ground. In some embodiments, the first axis is parallel with the second axis.

In some embodiments, the gas turbine engine includes a drive shaft coupled with the input shaft. The drive shaft may rotate about an engine axis that is radially spaced apart from and parallel with the second axis. In some embodiments, the gearbox does not include a clutch.

According to another aspect of the disclosure, a method may include a number of steps. The method may include providing a gas turbine engine, a first propulsor, a second propulsor, and a gearbox having a differential that includes an input shaft coupled with the gas turbine engine, a first output shaft coupled with the first propulsor, a second output shaft coupled with the second propulsor, a first brake coupled with the first output shaft, and a second brake coupled with the second output shaft, and engaging the second brake while the first brake is disengaged to cause the gas turbine engine to drive only the first propulsor.

In some embodiments, the method may include disengaging the second brake and engaging the first brake after the second brake is disengaged to cause the gas turbine engine to drive only the second propulsor. In some embodiments, the method may include engaging the first brake while simultaneously disengaging the second brake. In some embodiments, the method may include rotating the first propulsor about a vertical axis relative to ground, rotating the second propulsor about a horizontal axis relative to ground, and blocking rotation of the first propulsor after rotating the second propulsor.

These and other features of the present disclosure will become more apparent from the following description of the illustrative embodiments.

### BRIEF DESCRIPTION OF THE DRAWINGS

FIG. 1 is a diagrammatic view of a gas turbine engine system in accordance with the present disclosure showing that the gas turbine engine system includes a gas turbine engine, a gearbox coupled with the gas turbine engine, a first propulsor coupled with the gearbox and configured to propel an aircraft, and a second propulsor coupled with the gearbox and configured to propel the aircraft;

FIG. 2 is a diagrammatic view of the gas turbine engine system of FIG. 1 showing that the gearbox includes a differential coupled with the first propulsor and with the second propulsor, a first brake, and a second brake and suggesting that the first brake and the second brake are configured to engage the differential selectively to select between the first propulsor and the second propulsor propelling the aircraft;

FIG. 3 is a diagrammatic view of a portion of the gas turbine engine system of FIG. 1 showing that the gearbox includes the differential, an input shaft coupled with the gas turbine engine, a first output shaft coupled with the first propulsor, a second output shaft coupled with the second propulsor, the first brake coupled with the first input shaft, and the second brake coupled with the second input shaft;

FIG. 4 is a diagrammatic view of the differential included in the gearbox of the gas turbine engine system of FIG. 2 showing that the differential includes a ring gear coupled with the input shaft and a pinion gear of a drive shaft of the gas turbine engine, first and second spider gears, a first drive gear coupled with the first input shaft, and a second drive gear couple with the second input shaft;

FIG. 5 is a diagrammatic view of the gas turbine engine system of FIG. 1 showing the first brake is disengaged so that the first propulsor is driven by the gas turbine engine through the gearbox to propel the aircraft and the second propulsor is blocked from rotating by engagement of the second brake;

FIG. 6 is a diagrammatic view of the aircraft of FIG. 1 showing that the second brake is disengaged so that the second propulsor is driven by the gas turbine engine through the gearbox to propel the aircraft and the first propulsor is blocked from rotating by engagement of the first brake;

FIG. 7 is a graph showing the speed of each propulsor as a percent of revolutions per minute vs time in response to engage of the second brake and the first brake respectively; and

FIG. 8 is a diagrammatic view of another embodiment of the gas turbine engine system of FIG. 1 suggesting that the first propulsor and the second propulsor are configured to rotate about axes that are coaxial.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

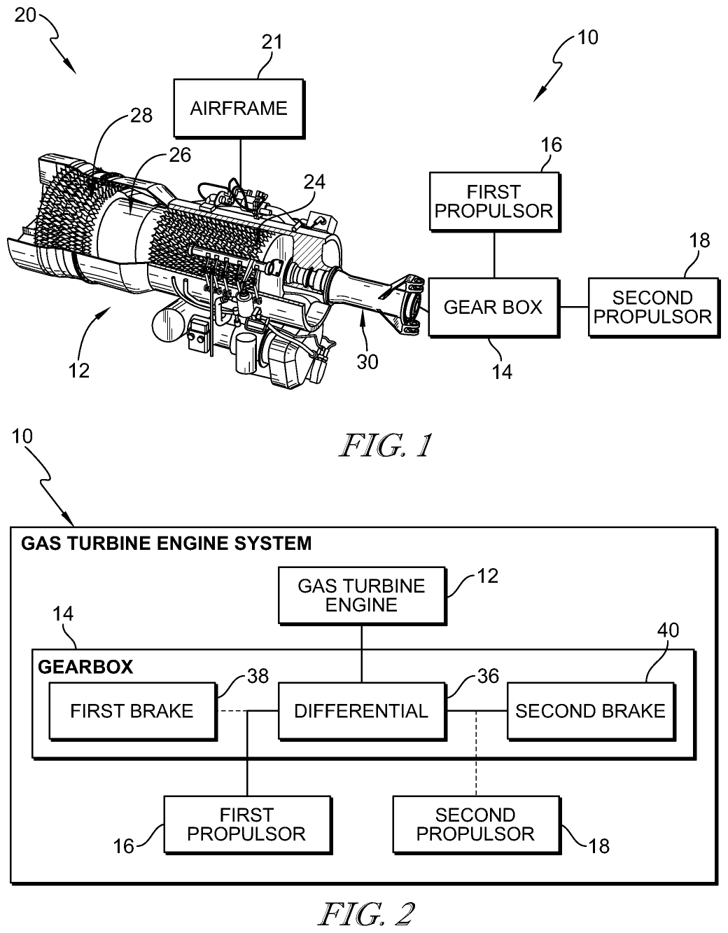

A gas turbine engine system 10 in accordance with the present disclosure includes a gas turbine engine 12, a gearbox 14, a first propulsor 16, and a second propulsor 18 as suggested in FIGS. 1 and 2. The gas turbine engine 12 is configured to generate power for driving the first propulsor 16 and/or the second propulsor 18. The gearbox 14 is coupled with the gas turbine engine 12, the first propulsor 16, and the second propulsor 18 and configured to selectively transmit power from the gas turbine engine 12 to the first propulsor 16 and/or the second propulsor 18 to cause one of the first propulsor 16 and the second propulsor 18 to propel the gas turbine engine system 10.

A cutaway view of the gas turbine engine 12 is shown in FIG. 1 to show that the gas turbine engine 12 includes a compressor 24, a combustor 26, and a turbine 28. The compressor 24 compresses and delivers air to the combustor 26. The combustor 26 mixes fuel with the compressed air received from the compressor 24 and ignites the fuel. The hot, high-pressure gases from the burning fuel are directed into the turbine 28 where the turbine 28 extracts work from the gases to drive the compressor 24, the first propulsor 16, and the second propulsor 18 through the gearbox 14.

The gearbox 14 is configured to transmit the power generated by the gas turbine engine 12 to first propulsor 16 and the second propulsor 18 so that only the gas turbine engine system 10 is propelled only by the first propulsor 16 or the second propulsor 18 during steady state conditions as suggested in FIG. 2. The gearbox 14 may be considered a dual propulsor gearbox. During transition periods in which the gas turbine engine system 10 is switching power between the first propulsor 16 and the second propulsor 18, both propulsors 16, 18 may be powered simultaneously. Transition periods are configured to be relatively short such that the gas turbine engine system 10 is primarily propelled by only one of the first propulsor 16 and the second propulsor 18.

In the illustrative embodiment, the first propulsor 16 is a main rotor configured to provide vertical lift and the second propulsor 18 is a turboprop or turbofan configured to provide thrust for an aircraft. The first propulsor 16 may be used to propel the gas turbine engine system 10 during take-off and landing. The second propulsor 18 may be used during cruise or other conditions to attain greater travel speeds relative to using the first propulsor 16. In other embodiments, the first propulsor 16 and the second propulsor 18 comprise fans. In other embodiments, each of the first propulsor 16 and the second propulsor 18 may include a shaft, rotor, turboprop, gearbox, propeller, helicopter main rotor, or helicopter tail rotor.

The gas turbine engine system 10 may be part of an aircraft 20 that includes an airframe 21 as suggested in FIG. 1. The airframe 21 is configured to support a pilot and, in some embodiments, passengers therein. IN other embodiments, the airframe 21 could be unmanned. The gas turbine engine system 10 is configured to couple with the airframe 21 for movement therewith.

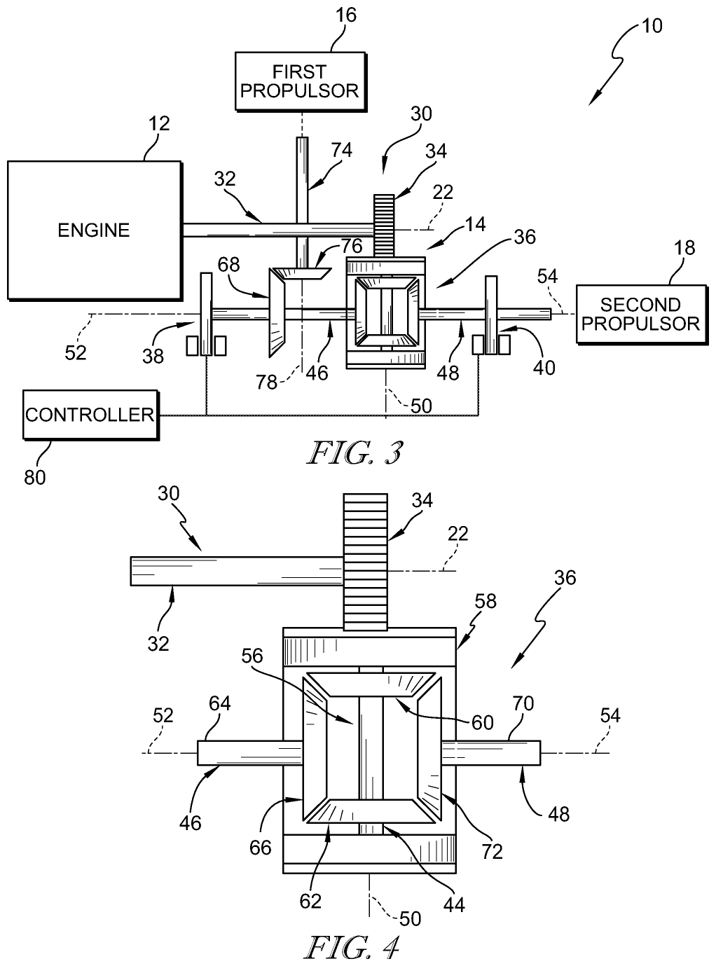

The gas turbine engine 12 includes the compressor 24, the combustor 26, and the turbine 28 as shown in FIG. 1. The gas turbine engine 12 further includes a drive shaft 30 as shown in FIGS. 3 and 4. The drive shaft 30 is coupled with the turbine 28 and the gearbox 14 to transmit power from the turbine 28 to the gearbox 14 during operation of the gas turbine engine 12. The drive shaft 30 includes a shaft 32 configured to be driven for rotation about an engine axis 22 by the turbine 28 and a pinion gear 34 coupled with the drive shaft 30 for rotation about the engine axis 22 as suggested in FIG. 3. The pinion gear 34 is coupled with the gearbox 14 to transmit power from the turbine 28 to the gearbox 14 and, thus, to drive the gearbox 14.

The drive shaft 30 is coupled for rotation directly with a turbine section of the turbine 28 and a compressor section of the compressor 24 in some embodiments. In some embodiments, the gas turbine engine includes an auxiliary gearbox coupled between the turbine 28 and the drive shaft 30 and the auxiliary gearbox is configured to vary a rotational speed and/or torque of the drive shaft 30 compared to the rotational speed of the turbine 28.

The gearbox 14 includes a differential 36, a first brake 38, and a second brake 40 as shown in FIGS. 2 and 3. The differential 36 is coupled with the drive shaft 30 included in the gas turbine engine 12, the first propulsor 16, and the second propulsor 18. The differential 36 is configured to transmit power from the drive shaft 30 to the first propulsor 16 and/or the second propulsor 18. The first brake 38 is coupled with the differential 36 and configured to block selectively rotation of the first propulsor 16 by blocking the differential 36 from transmitting power to the first propulsor 16. The second brake 40 is coupled with the differential 36 and configured to block selectively rotation of the second propulsor 18 by blocking the differential 36 from transmitting power to the first propulsor 16.

The differential 36 includes an input shaft 44, a first output shaft 46, and a second output shaft 48 as shown in FIGS. 3 and 4. The input shaft 44 is coupled to the gas turbine engine 12 through the drive shaft 30. The first output shaft 46 is coupled with the first propulsor 16 and the first brake 38. The second output shaft 48 is coupled with the second propulsor 18 and the second brake 40. The input shaft 44 is configured to rotate about an axis 50. The first output shaft 46 is configured to rotate about an axis 52. The second output shaft 48 is configured to rotate about an axis 54.

The axis 50 is perpendicular to the engine axis 22 in the illustrative embodiment as shown in FIG. 3. The axis 52 is perpendicular to the axis 50 in the illustrative embodiment. The axis 54 is perpendicular to the axis 50 in the illustrative embodiment. The axis 52 is spaced apart radially from the engine axis 22 relative to the engine axis 22. The axis 52 is spaced apart radially from the engine axis 22 relative to the engine axis 22. The axis 52 is parallel with the engine axis 22 in the illustrative embodiment. The axis 54 is parallel with the engine axis 22 in the illustrative embodiment. The axis 52 is parallel with and coaxial with the axis 52 in the embodiment shown in FIG. 3.

The input shaft 44 includes a shaft 56, a ring gear 58 coupled with the shaft 56 and engaged with the pinion gear 34, a first spider gear 60 arranged around the axis 50, and a second spider gear 62 arranged around the axis 50 as shown in FIG. 4. The first output shaft 48 includes a shaft 64, a first propulsor drive gear 66 coupled with the shaft 64 and a bevel gear 68 coupled with the shaft 64. The second output shaft 48 includes a shaft 70 and a second propulsor drive gear 72 coupled with the shaft 70. The first propulsor drive gear 66 is engaged with the first spider gear 60 and the second spider gear 62. The second propulsor drive gear 72 is engaged with the first spider gear 60 and the second spider gear 62.

The first brake 38 is configured to block selectively rotation of the first output shaft 46 as suggested in FIG. 3. The second brake 40 is configured to block selectively rotation of the second output shaft 48. The first brake 38 and the second brake 40 may comprise any combination of brake types such as, for example, disk brakes, drum brakes, hydraulic brakes, etc. The brakes 38, 40 are configured to completely block rotation of the propulsor 16, 18. As such, the brakes 38, 40 may generate heat during the braking process, but may generate little to no heat once the output shaft 46 or 48 is stopped. The brakes 38, 40 use minimal energy no energy to maintain the output shafts 46, 48 in the stopped arrangement in which they are blocked from rotating as compared to clutches or alternative systems which may require parasitic energy and/or create heat waste. The gearbox 14 does not include a clutch in illustrative embodiments. The brakes 38, 40 do not use continuous or parasitic energy once the respective output shaft 46, 48 is stopped from rotating by the brake 38, 40.

The gearbox 14 further includes a shaft 74 and a bevel gear 76 in the illustrative embodiment as shown in FIG. 3. The shaft 74 is connected to the first propulsor 16 and is configured to rotate the first propulsor 16 about an axis 78. The bevel gear 76 is coupled with the shaft 74 and engages the bevel gear 68. The axis 78 is perpendicular to the axis 54 in the illustrative embodiment. The axis 78 is substantially vertical in the illustrative embodiment and the axis 54 is substantially horizontal relative to ground. As such, the first propulsor 16 is configured to provide lift and the second propulsor 18 is configured to provide thrust. That is, the axis 78 extends in a vertical direction and the axis 54 extends in a horizontal direction relative to ground.

In other embodiments, the axis 78 is parallel with the axis 54 as shown in FIG. 8. In some embodiments, the axis 78 is coaxial with the axis 54 as shown in FIG. 8. The axis 78 intersects the axis 54 in some embodiments.

In the illustrative embodiment, the first propulsor 16 is a main rotor configured to provide vertical lift and the second propulsor 18 is a turboprop or turbofan configured to provide thrust for an aircraft. In other embodiments, the first propulsor 16 and the second propulsor 18 comprise fans. In other embodiments, each of the first propulsor 16 and the second propulsor 18 may include a shaft, rotor, turboprop, gearbox, propeller, helicopter main rotor, or helicopter tail rotor. The gas turbine engine system 10 may be used in industrial settings such that the propulsors 16, 18 are replaced with shafts for providing rotational energy.

The first brake 38 is coupled with the first output shaft 46 and movable between an engaged position in which the first brake 38 blocks rotation of the first output shaft 46 and a disengaged position in which the first output shaft 46 is free to rotate. In the disengaged position of the first brake 38, the first output shaft 46 is free to rotate the first propulsor 16 when the gas turbine engine 12 is operating. The second brake 40 is coupled with the second output shaft 48 and movable between an engaged position in which the second brake 40 blocks rotation of the second output shaft 48 and a disengaged position in which the second output shaft 48 is free to rotate. In the disengaged position of the second brake 40, the second output shaft 48 is free to rotate the second propulsor 18 when the gas turbine engine 12 is operating.

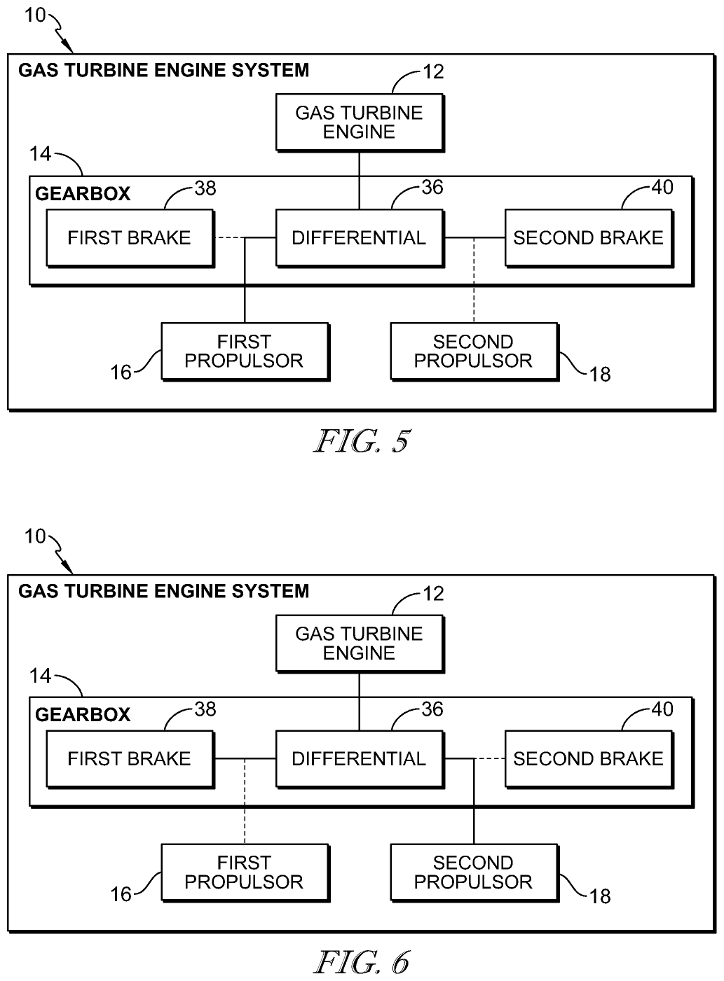

The gearbox 14 is operable in a first power mode as shown in FIG. 5 and a second power mode as shown in FIG. 6. In the first power mode, the first brake 38 is disengaged and the second brake 40 is engaged so that the gas turbine engine system 10 is propelled only by the first propulsor 16. In the second power mode, the first brake 38 is engaged and the second brake 40 is disengaged so that the gas turbine engine system 10 is propelled only by the second propulsor 18.

The gearbox 14 is operable in a third power mode in some embodiments. In the third power mode, the first brake 38 is disengaged and the second brake is disengaged 40. As such, the first propulsor 16 and the second propulsor 18 are driven by the differential 36 during operation of the gas turbine engine 12. The third power mode may be used during transition between the first power mode and the second power mode.

The gearbox 14 may further include a controller 80 as shown in FIG. 3. The controller 80 is connected with the first brake 38 and the second brake 40 and is configured to control engagement and disengagement of the brakes 38, 40. In some embodiments, the controller engages the first brake 38 while the second brake 40 remains engaged for a period of time before the second brake 40 is released to operate in the second power mode. In some embodiments, the controller engages the second brake 40 while the first brake 38 remains engaged for a period of time before the first brake 38 is released to operate in the first power mode. In some embodiments, the controller simultaneously engages one brake 38, 40 and disengages the other brake 40, 38 to switch between power modes.

A method of using the gas turbine engine system 10 includes engaging the second brake 40 while the first brake 38 is disengaged to cause the gas turbine engine 12 to drive only the first propulsor 16. As a result, the gas turbine engine system 10 is propelled only by the first propulsor. The method may include disengaging the second brake 40 and engaging the first brake 38 after the second brake 40 is disengaged to cause the gas turbine engine 12 to drive only the second propulsor 18.

The method may include engaging the first brake 38 while simultaneously disengaging the second brake 40. The method may include rotating the first propulsor 16 about a vertical axis 78 relative to ground. The method may include rotating the second propulsor 18 about a horizontal axis 54 relative to ground. The method may include blocking rotation of the first propulsor 16 after rotating the second propulsor 18.

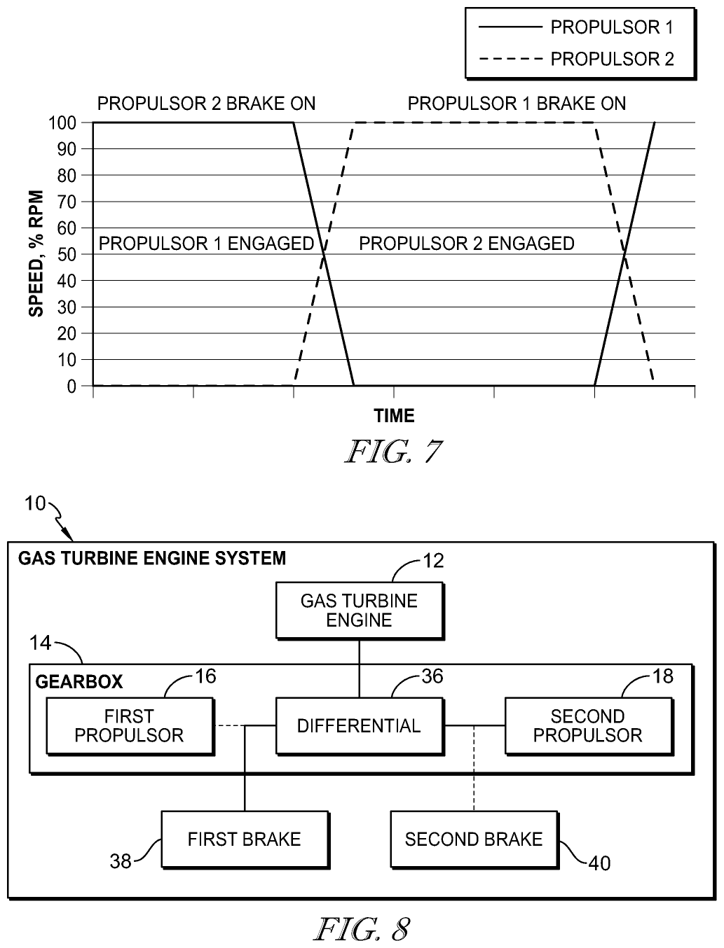

In use, the gearbox 14 may be in the first power mode such that the first propulsor 16 is propelling the gas turbine engine system 10. As a result, the first propulsor 16 has a rotational speed indicated as being 100 percent RPM as suggested in FIG. 7 while the second propulsor 18 is stopped as indicated as being 0 percent RPM. The first propulsor 16 may provide vertical lift for take-off and, in some cases, some forward thrust via vectoring or another thrust system other than the second propulsor 18.

The gearbox 14 is then switched to power mode two such that the second brake 40 is disengaged and the first brake 38 is engaged so that the first propulsor 16 speed drops to 0 percent RPM and the second propulsor 18 speed rises to 100 percent RPM. The second propulsor 18 may be a fan that provides forward thrust for the system 10. The gearbox 14 is then switched to power mode one such that the second brake 40 is engaged and the first brake 38 is disengaged so that the first propulsor 16 speed rises to 100 percent RPM and the second propulsor 18 speed reduces to 0 percent RPM so that that the first propulsor 16 provides lift such as, for example, during landing or for hovering as suggested in FIG. 7.

The gearbox 14 for dual propulsors 16, 18 of the present disclosure may provide a simple, lightweight solution to switching engine power from one propulsor to another. In some aircrafts, switching power from one propulsor to another may be achieved using two clutches which may add complexity and weight to the system. The present disclosure provides a system for switching power without clutches.

Power is transmitted to the differential 36 through engine shafting and a pinion gear 34 in the illustrative embodiment. The differential ring gear 58, which is driven by the pinion gear 34, rotates a carrier which contains the spider gears 60, 62. When power is required to drive the first propulsor 16, the second propulsor brake 40 is engaged to prevent rotation of the second propulsor shaft 70. When power is required to drive the second propulsor 18, the second propulsor brake 40 is released and the first propulsor brake 38 is engaged. FIG. 7 shows the speed of the two propulsors as a function of time during use of the gas turbine engine system 10.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A gas turbine engine system comprising
a gearbox that includes a differential, a first brake, and a second brake, the differential having an input shaft, a first output shaft, and a second output shaft, the first brake coupled with the first output shaft and movable between an engaged position in which the first brake blocks rotation of the first output shaft and a disengaged position in which the first output shaft is free to rotate, and the second brake coupled with the second output shaft and movable between an engaged position in which the second brake blocks rotation of the second output shaft and a disengaged position in which the second output shaft is free to rotate,
a gas turbine engine coupled to the input shaft of the differential and configured to drive the differential during operation of the gas turbine engine,
a first propulsor coupled with the first output shaft included in the differential of the gearbox and configured to rotate about a first axis selectively to propel the gas turbine engine system in response to rotation of the first output shaft, and
a second propulsor coupled with the second output shaft included in the differential of the gearbox and configured to rotate about a second axis selectively to propel the gas turbine engine system in response to rotation of the second output shaft,
wherein the gearbox is operable in a first power mode in which the first brake is disengaged and the second brake is engaged so that the gas turbine engine system is propelled only by the first propulsor and a second power mode in which the first brake is engaged and the second brake is disengaged so that the gas turbine engine system is propelled only by the second propulsor.

2. The gas turbine engine system of claim 1, wherein the gearbox is further operable in a third power mode in which the first brake is disengaged and the second brake is disengaged.

3. The gas turbine engine system of claim 1, wherein the first axis intersects the second axis.

4. The gas turbine engine system of claim 3, wherein the first axis is perpendicular to the second axis.

5. The gas turbine engine system of claim 1, wherein the first axis is substantially vertical and the second axis is substantially horizontal relative to ground.

6. The gas turbine engine system of claim 5, wherein the gas turbine engine includes a drive shaft that extends along an engine axis, the first output shaft is spaced apart radially from and is parallel with the drive shaft relative to the engine axis, the second output shaft is spaced apart radially from and is parallel with the drive shaft relative to the engine axis, and the differential further includes a bevel gear coupled with the first output shaft and configured to drive the first propulsor.

7. The gas turbine engine system of claim 1, wherein the first axis and the second axis are coaxial.

8. A gas turbine engine system comprising
a gas turbine engine,
a gearbox that includes a differential, a first brake, and a second brake, the differential having an input shaft coupled with the gas turbine engine, a first output shaft, and a second output shaft, the first brake coupled with the first output shaft and configured to block selectively rotation of the first output shaft, and the second brake coupled with the second output shaft and configured to block selectively rotation of the second output shaft,
a first propulsor configured to be rotated about a first axis by the first output shaft, and
a second propulsor configured to be rotated about a second axis by the second output shaft.

9. The gas turbine engine system of claim 8, wherein the first brake is movable between an engaged position in which the first brake blocks rotation of the first output shaft and a disengaged position in which the first output shaft is free to rotate and the second brake is movable between an engaged position in which the second brake blocks rotation of the second output shaft and a disengaged position in which the second output shaft is free to rotate and drive rotation of the second propulsor.

10. The gas turbine engine system of claim 9, wherein the gearbox is operable in a first power mode in which the first brake is disengaged and the second brake is engaged so that the gas turbine engine system is propelled only by the first propulsor and a second power mode in which the first brake is engaged and the second brake is disengaged so that the gas turbine engine system is propelled only by the second propulsor.

11. The gas turbine engine system of claim 8, wherein the first axis intersects the second axis.

12. The gas turbine engine system of claim 8, wherein the first axis is perpendicular to the second axis.

13. The gas turbine engine system of claim 8, wherein the first axis extends in a vertical direction and the second axis extends in a horizontal direction relative to ground.

14. The gas turbine engine system of claim 8, wherein the first axis is parallel with the second axis.

15. The gas turbine engine system of claim 8, wherein the gas turbine engine includes a drive shaft coupled with the input shaft and the drive shaft rotates about an engine axis that is radially spaced apart from and parallel with the second axis.

16. The gas turbine engine system of claim 8, wherein the gearbox does not include a clutch.

17. A method comprising
providing a gas turbine engine, a first propulsor, a second propulsor, and a gearbox having a differential that includes an input shaft coupled with the gas turbine engine, a first output shaft coupled with the first propulsor, a second output shaft coupled with the second propulsor, a first brake coupled with the first output shaft, and a second brake coupled with the second output shaft, and
engaging the second brake while the first brake is disengaged to cause the gas turbine engine to drive only the first propulsor.

18. The method of claim 17, further comprising disengaging the second brake and engaging the first brake after the second brake is disengaged to cause the gas turbine engine to drive only the second propulsor.

19. The method of claim 17, further comprising engaging the first brake while simultaneously disengaging the second brake.

20. The method of claim 17, further comprising rotating the first propulsor about a vertical axis relative to ground, rotating the second propulsor about a horizontal axis relative to ground, and blocking rotation of the first propulsor after rotating the second propulsor.
